(19) United States
(12) Patent Application Publication
(10) Pub. No.: US 2012/0231327 A1
(43) Pub. Date: Sep. 13, 2012

(54) POSITIVE ELECTRODE ACTIVE MATERIAL FOR NON-AQUEOUS ELECTROLYTE SECONDARY BATTERY, PROCESS FOR PRODUCTION OF SAME, AND NON-AQUEOUS ELECTROLYTE SECONDARY BATTERY PRODUCED USING SAME

(75) Inventor: Hidekazu Hiratsuka, Osaka (JP)

(73) Assignee: PANASONIC CORPORATION, Osaka (JP)

(21) Appl. No.: 13/509,046

(22) PCT Filed: Mar. 9, 2011
(86) PCT No.: PCT/JP2011/001368

§ 371 Date: May 10, 2012

(30) Foreign Application Priority Data
Mar. 10, 2010 (JP) 2010-052689

(51) Int. Cl. H01M 4/38; H01M 2/02

(52) U.S. Cl. 429/163; 252/182.1

(57) ABSTRACT

At the time of synthesis of lithium nickelate, by adding a firing aid to material to be fired, crystal growth is promoted at a temperature that is lower than a firing temperature necessary for obtaining desired crystal growth of lithium nickelate, and substitution of elements that contribute to structural stability in crystals is promoted. Furthermore, distortion of crystal or loss of oxygen at the time of synthesis is suppressed. Thus, a lithium ion secondary battery having excellent charge and discharge characteristics and cycling characteristics can be provided.

### TECHNICAL FIELD

The present invention relates to a positive electrode active material for a non-aqueous electrolytic solution secondary battery, a manufacturing method for the same, and a non-aqueous electrolytic solution secondary battery using the same.

### BACKGROUND ART

Recently, with rapid spread of portable and cordless electronic devices, small secondary batteries with lightweight and large energy density as driving power sources for such devices have been increasingly in demand. From such a viewpoint, as batteries having a high voltage and a large energy density, non-aqueous secondary batteries, in particular, a lithium ion secondary battery, are largely expected. At present, a lithium ion secondary battery in which carbon material is used for a negative electrode, lithium cobaltate (LiCoO₂) as a lithium intercalation compound having a layered structure is used for a positive electrode, and an organic electrolytic solution is used as an electrolyte has been put to practical use. Electric potential of lithium cobaltate as positive electrode active material is high as about 4V on the basis of lithium, the specific capacity density thereof is large as about 140 mAh/g, and the charge and discharge cycle lifetime thereof is long. Lithium cobaltate has advantages in these points.

However, due to a small amount of resources of Co, from the viewpoint of cost, and furthermore, from the viewpoint of development of lithium ion secondary batteries having a larger energy density, development of a positive electrode using lithium-containing composite oxides instead of lithium cobaltate has been progressing. Among them, much attention is being paid to positive electrode active material, mainly lithium nickelate (LiNiO₂).

A charging voltage of a lithium ion secondary battery using lithium cobaltate is generally 4.3 V. On the other hand, a charging voltage of a lithium ion secondary battery using lithium nickelate is 4.2 V. Although the charging voltage is 4.2 V, lithium nickelate is expected to have an energy density larger than that of lithium cobaltate by about 20%. On the contrary, however, this material releases much lithium (Li) at the time of charging, and therefore the layer structure tends to be unstable. In other words, structural stability at the time of charging is low. Furthermore, since tetravalent nickel is thermally unstable, lithium nickelate releases oxygen at a relatively low temperature, and nickel is reduced to the valence of two or less. As a result, there is a concern that reliability and safety of batteries are lowered.

In order to secure reliability and safety, in batteries, in addition to the positive electrode active material, various measures have been taken to secure safety. Ideally, however, it is desirable that structural stability of the positive electrode active material itself be secured. In such circumstances, a structure has been attempted to be stabilized by giving various additives to positive electrode active material.

For example, in order to suppress complicated changes in a crystalline structure due to charging and discharging, material in which about 10% of nickel in an element ratio is substituted with cobalt is used. Furthermore, in order to secure thermal structural stability at the time of charging, LiNi_{1-x-z}CoₓAl_{z}O₂ in which nickel is substituted with aluminum has been studied (see, for example, PTL 1).

Furthermore, on the other hand, since a capacity and charge and discharge characteristics of lithium nickelate are changed depending on a synthesizing method, it is relatively difficult to mass-produce homogeneous and high-performance active material. Since in lithium nickelate, a nickel ion, a lithium ion and an oxygen ion as a crystal skeleton have relatively low binding force, when it is fired at a high temperature at the time of synthesis, distortion of crystal or a loss of oxygen may easily occur, thus deteriorating battery characteristics.

Conventionally, as a method for manufacturing lithium nickelate, for example, as shown in PTL 2, a method of mixing a nickel compound such as nickel oxide and lithium hydroxide with each other, preliminarily firing the mixture at 600° C. in the atmosphere of air, then re-pulverizing, and sintering at a temperature ranging from 600° C. to 800° C. is proposed.

This manufacturing method attempts to suppress distortion of crystal and loss of oxygen so as to prevent battery characteristics from being deteriorated, by enhancing the reactivity at the time of synthesis and forming crystals at a lower temperature.

However, in a conventional method in which various elements are added and elements are substituted to the inside of crystal in order to secure the structural stability of lithium nickelate, a large amount of heat is required, and firing at a high temperature is necessary.

When firing is carried out at a high temperature, due to volatilization of a lithium ion as a constituent element of lithium nickelate or due to loss of oxygen, distortion of crystal or loss of oxygen tend to occur, resulting in deterioration of battery characteristics. That is to say, it is difficult to suppress the distortion of crystal at the time of synthesis or the loss of oxygen while various elements are added in order to secure the structural stability of lithium nickelate, and there is a problem for achieving excellent charge and discharge characteristics and cycling characteristics.

### CITATION LIST

### Patent Literature

PTL 1: Japanese Patent Application Unexamined Publication No. H9-237631
PTL 2: Japanese Patent Application Unexamined Publication No. H2-040861

### SUMMARY OF THE INVENTION

The present invention provides a manufacturing method for positive electrode active material for a non-aqueous electrolytic solution secondary battery in which even when elements for ensuring structural stability are added, substitution thereof can be carried out at a low temperature; positive electrode active material manufactured by the method; and a non-aqueous electrolytic solution secondary battery using the same.

The manufacturing method for positive electrode active material in a non-aqueous electrolytic solution secondary battery according to the present invention includes preparing a mixture by mixing a nickel compound of nickel (Ni) and at least one of elements selected from the group consisting of cobalt (Co), manganese (Mn), aluminum (Al), magnesium (Mg), titanium (Ti), strontium (Sr), zirconium (Zr), yttrium (Y), molybdenum (Mo) and tungsten (W), a lithium compound, and a firing aid; and firing the mixture. The melting point of the firing aid is lower than the firing temperature of the mixture.

According to the present invention, by using a firing aid, firing of lithium nickelate can be carried out at a low temperature. Therefore, it is possible to secure structural stability by substitution of elements that contribute to structural stability, and it is possible to suppress distortion of crystal and loss of oxygen at the time of synthesis. As a result, a lithium ion secondary battery having excellent charge and discharge characteristics and cycling characteristics can be manufactured, and a positive electrode active material in a non-aqueous electrolytic solution secondary battery having high mass-productivity can be provided.

### BRIEF DESCRIPTION OF DRAWINGS

FIG. 1 is a longitudinal sectional view schematically showing a configuration of a cylindrical non-aqueous electrolytic solution secondary battery of one exemplary embodiment of the present invention.

### DESCRIPTION OF EMBODIMENTS

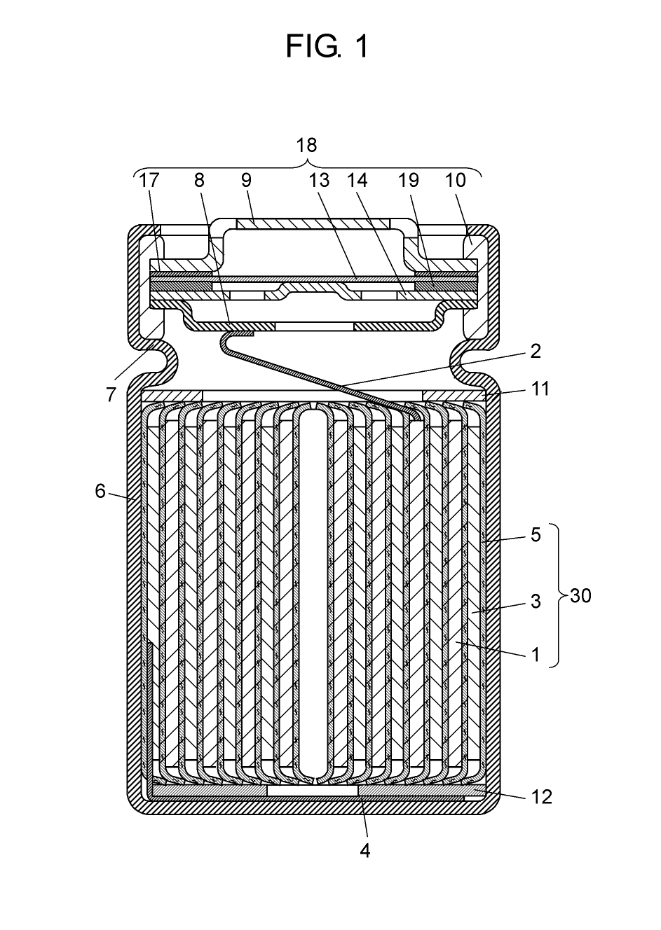

As shown in FIG. 1, a non-aqueous electrolytic solution secondary battery of the present invention can be configured in the same manner as in a conventional non-aqueous electrolytic solution secondary battery except for using positive electrode active material for a non-aqueous electrolytic solution secondary battery of the present invention. FIG. 1 is a longitudinal sectional view schematically showing a configuration of a cylindrical non-aqueous electrolytic solution secondary battery in accordance with one exemplary embodiment of the present invention. The cylindrical lithium ion secondary battery includes electrode group 30, a non-aqueous electrolytic solution (or non-aqueous electrolyte) (not shown), battery case 6, and seal member 18. Electrode group 30 includes positive electrode 1, negative electrode 3, and separator 5 disposed between positive electrode 1 and negative electrode 3. Electrode group 30 is impregnated with the non-aqueous electrolytic solution. Battery case 6 accommodates electrode group 30 and the non-aqueous electrolytic solution. Seal member 18 seals an opening of battery case 6. Furthermore, the upper and lower parts of electrode group 30 are provided with upper insulating plate 11 and lower insulating plate 12, respectively.

A little below the upper end of the opening of battery case 6, an inward groove is provided, so that annular support part 7 is formed in such a manner that it protrudes toward the inner side of battery case 6. Seal member 18 is fitted to annular support part 7. The circumference of seal member 18 is provided with insulating gasket 10. Insulating gasket 10 insulates battery case 6 and seal member 18. Furthermore, the open end of battery case 6 is crimped onto insulating gasket 10. Seal member 18 and insulating gasket 10 close battery case 6. Seal member 18 is composed of plate 8, cap 9 as a terminal for external connection, and upper valve 13 disposed between plate 8 and cap 9, filter 19, and lower valve 14.

Positive electrode lead 2 led out from positive electrode 1 is connected to plate 8, and negative electrode lead 4 led out from negative electrode 3 is connected to the inner bottom of battery case 6. Furthermore, PTC device 17 is disposed between cap 9 and upper valve 13. PTC device 17 self-heats when a large amount of electric current flows in the non-aqueous electrolytic solution secondary battery, and the resistance value thereof becomes extremely large. With this operation, PTC device 17 limits an electric current. Therefore, the safety is further enhanced.

Positive electrode 1 includes a positive electrode current collector and a positive electrode active material layer. The positive electrode active material layer supported by the surface of the positive electrode current collector contains positive electrode active material manufactured by using the below-mentioned nickel hydroxide. Positive electrode 1 is produced by, for example, coating both surfaces of the positive electrode current collector with a positive electrode paste, drying thereof, and roll-pressing thereof to form the positive electrode active material layers. Furthermore, positive electrode 1 is provided with a blank portion on which no active material layer is formed and the positive electrode current collector is exposed, and positive electrode lead 2 is welded on the blank portion.

Negative electrode 3 is produced by, for example, coating one surface or both surfaces of the negative current collector with a negative electrode paste, drying thereof, and roll-pressing thereof to form the negative electrode active material layers. Furthermore, negative electrode 3 is provided with a blank portion on which no active material layer is formed and the negative electrode current collector is exposed, and negative electrode lead 4 is welded on the blank portion.

It is preferable that the negative electrode current collector is made of copper foil, and the thickness thereof is in the range from 5 μm to 30 μm. Furthermore, the surfaces of the negative electrode current collector may be subjected to lath processing or etching processing.

The negative electrode paste is prepared by mixing negative electrode active material, a binder, and a dispersion medium. Also, the negative electrode paste may contain a conductive agent, a thickener, and the like, if necessary. For such material, for example, the same material as material for the below-mentioned positive electrode paste can be used.

Although the negative electrode active material is not particularly limited, it is preferable to use a carbon material capable of absorbing and releasing lithium ions due to charge and discharge.

Preferable examples include carbon material obtained by firing an organic polymer compound (phenolic resin, polyacrylonitrile, cellulose, and the like), carbon material obtained by firing coke or pitch, artificial graphite, natural graphite, pitch-type carbon fibers, and PAN-type carbon fibers. Examples of the shape of the negative electrode active material include a fiber shape, a sphere shape, scale shape, a massive shape, and the like.

In order to produce positive electrode 1 by using lithium nickelate in accordance with this exemplary embodiment, a method that is the same as a conventional method can be employed. For example, a positive electrode active material layer is formed by applying a positive electrode paste containing positive electrode active material onto the positive electrode current collector, drying thereof, and further roll-pressing thereof if necessary, and thus, positive electrode 1 can be produced. The positive electrode active material layer may be formed on one surface or both surfaces in the thickness direction of the positive electrode current collector. The positive electrode active material layer preferably has thickness of 20 to 150 μm when it is formed on one surface of the positive electrode current collector, and preferably has a total thickness of 50 to 250 μm when the positive electrode active material layers are formed on both surfaces of the positive electrode current collector.

As the positive electrode current collector, material commonly used in the field of non-aqueous electrolyte secondary batteries can be used. Examples of the material include sheets and foil containing stainless steel, aluminum, an aluminum alloy, titanium, or the like. Among them, aluminum, an aluminum alloy, or the like, are more preferable. The sheet may be made of porous material. Examples of the porous material include foam, woven fabric, and non-woven fabric. Although the thickness of the sheet or foil is not particularly limited, it is usually 1 to 500 μm, and preferably 10 to 60 μm. The surface of the positive electrode current collector may be subjected to a lath process or etching process.

The positive electrode paste may contain a conductive agent, a binder, a thickener, a dispersion medium, and the like, in addition to the positive electrode active material.

Examples of the conductive agent include carbon black, graphite, carbon fibers, metal fibers, and the like. Examples of carbon black include acetylene black, ketjen black, channel black, furnace black, lamp black, and thermal black. The conductive agents can be used singly or in combination of two or more of them.

The binder is not particularly limited and any material can be used as long as it is capable of being dissolved or dispersed in the dispersion medium. Examples thereof include polyethylene, polypropylene, fluorocarbon binders, rubber particles, acrylic polymers, vinyl polymers, and the like. Examples of the fluorocarbon binders include polytetrafluoroethylene (PTFE), polyvinylidene fluoride (PVDF), a tetrafluoroethylene-hexafluoropropylene copolymer (FEP), a vinylidene fluoride-hexafluoropropylene copolymer, and the like.

They are preferably used in the form of dispersion. Examples of the rubber particles include acrylic rubber particles, styrene-butadiene rubber (SBR) particles, acrylonitrile rubber particles, and the like. Among them, binders containing fluorine are preferable in consideration of, for example, improving the oxidation resistance of the positive electrode active material layer. These binders can be used singly or in combination of two or more of them.

For the thickener, material commonly used in this field can be used. Examples include an ethylene-vinyl alcohol copolymer, carboxymethyl cellulose (sodium salt), methyl cellulose, and the like.

The dispersion medium is appropriately one into which a binder is capable of being dispersed or dissolved. When an organic binder is used, preferable examples of the dispersion medium include amides such as N,N-dimethylformamide, dimethyl acetamide, methyl formamide, hexamethylsulforamide, and tetramethyl urea; amines such as N-methyl-2-pyrrolidone (NMP) and dimethyl amine; ketones such as methyl ethyl ketone, acetone, and cyclohexanone; ethers such as tetrahydrofuran; and sulfoxides such as dimethyl sulfoxide. Among them, for example, NMP and methyl ethyl ketone are preferable. Also, when an aqueous binder such as SBR is used, the dispersion medium is preferably water or warm water. The dispersion media can be used singly or in combination of two or more of them.

In order to prepare the positive electrode paste, a method commonly used in this field can be employed. Examples of the methods include a method of mixing the above-described components with the use of a mixing device such as a planetary mixer, a homomixer, a pin mixer, a kneader, or a homogenizer. The mixing devices are used singly or in combination of two or more of them. Furthermore, in kneading of the positive electrode paste, various dispersing agents, surfactants, or stabilizers may be added, if necessary.

The positive electrode paste can be applied onto the surface of a positive electrode current collector using, for example, a slit die coater, a reverse roll coater, a lip coater, a blade coater, a knife coater, a gravure coater, or a dip coater. The positive electrode paste applied onto the positive electrode current collector is preferably dried in a manner close to air drying. However, in consideration of productivity, it is preferable to be dried in the dry air at a temperature of 70° C. to 200° C. for 10 minutes to 5 hours.

The positive electrode plate is roll-pressed at a linear pressure of 1000 to 2000 kg/cm several times until it has a predetermined thickness of 130 μm to 200 μm. Alternatively, the positive electrode plate may be roll-pressed with the linear pressure changed.

As separator 5, a microporous film made of polymer material is preferably used. Examples of the polymer material include polyethylene, polypropylene, polyvinylidene fluoride, polyvinylidene chloride, polyacrylonitrile, polyacrylamide, polytetrafluoroethylene, polysulfone, polyether sulfone, polycarbonate, polyamide, polyimide, polyether (polyethylene oxide or polypropylene oxide), cellulose (carboxymethyl cellulose or hydroxypropyl cellulose), poly(meth)acrylic acid, and poly(meth)acrylic acid ester. Such polymer material can be used singly or in combination of two or more of them. It is also possible to use a multi-layer film obtained by laminating these microporous films. Among them, a microporous film made of polyethylene, polypropylene, polyvinylidene fluoride, or the like, is preferable. The thickness of the microporous film is preferably 15 μm to 30 μm.

Battery case 6 is formed of copper, nickel, stainless steel, nickel plated steel, or the like. A metal plate made of such material is subjected to a process such as drawing, and thereby it can be shaped into a battery case. In order to enhance the corrosion resistance of battery case 6, battery case 6 after the process may be subjected to a plating process. Furthermore, when a battery case made of aluminum or an aluminum alloy is used, it is possible to produce a rectangular secondary battery having light weight and large energy density.

A non-aqueous solvent to be used for an electrolytic solution preferably contains cyclic carbonate or chain carbonate as a main component. For example, as the cyclic carbonate, it is preferable to use at least one selected from the group consisting of ethylene carbonate, propylene carbonate, and butylene carbonate. Also, as the chain carbonate, it is preferable to use at least one selected from the group consisting of, for example, dimethyl carbonate, diethyl carbonate, and ethyl methyl carbonate.

For the solute, for example, lithium salt whose anion has a functional group with a strong electron affinity is used. Examples thereof include LiPF₆, LiBF₄, LiClO₄, LiAsF₆, LiCF₃SO₃, LiN(SO₂CF₃)₂, LiN(SO₂C₂F₅)₂, LiC(SO₂CF₃)₃, and the like. These solutes may be used singly or in combination of two or more of them. Furthermore, it is preferable that these solutes are dissolved in the non-aqueous solvent at a concentration of 0.5 to 1.5 M.

For plate 8 constituting seal member 18, material resistant to an electrolytic solution (or to an electrolyte) and to heat can be used, but the material is not particularly limited. Among them, it is preferable to use seal member 18 made of aluminum or an aluminum alloy having a small specific gravity.

Upper valve 13 and lower valve 14 are preferably made of a flexible thin metal foil made of aluminum.

For positive electrode lead 2 and negative electrode lead 4, material known in the art can be used. For example, positive electrode lead 2 is made of aluminum. Negative electrode lead 4 is made of nickel.

The positive electrode active material of this exemplary embodiment is prepared by mixing a nickel compound including Ni and at least one of elements selected from the group consisting of Co, Mn, Al, Mg, Ti, Sr, Zr, Y, Mo, and W, a lithium compound, and a firing aid; and firing the mixture.

The melting point of the firing aid is lower than the firing temperature at which raw material of lithium nickelate is fired. Specifically, the melting point of the firing aid is lower than 700° C. In order to express excellent battery characteristics, it is necessary to grow crystals of lithium nickelate. In order to do so, when the firing aid is not used, the firing temperature is required to be increased to some extent. On the contrary, when the firing aid is added, crystal growth can be promoted at a temperature lower than such a general firing temperature, and substitution of elements that contribute to the structural stability into a crystal is promoted. Furthermore, distortion of crystal or loss of oxygen at the time of synthesis can be suppressed, thus a lithium ion secondary battery having excellent charge and discharge characteristics and excellent cycling characteristics can be manufactured. That is to say, the firing aid lowers the firing temperature capable of synthesizing the positive electrode active material.

As the mechanism of reaction, at the time of firing, when a temperature is raised from a state in which a nickel compound and a lithium compound as material to be fired, and a firing aid co-exist, only particles of the firing aid are melted first, a liquid phase is generated between the particles of the material to be fired. It is thought that the liquid phase then allows the particles of the material to be fired to attract to each other to make the gap therebetween smaller, thus increasing the density.

As the lithium compound which is one of the above-mentioned materials to be fired, well-known material can be used. Among them, lithium hydroxide is preferable. The ratio to be used of the nickel compound and the lithium compound is not particularly limited. It may be appropriately selected according to other configurations or applications of use of a non-aqueous electrolytic solution secondary battery using a target positive electrode active material.

In order to prepare the nickel compound, at least one of Co, Mn, Al, Mg, Ti, Sr, Zr, Y, Mo and W as an element that contributes to the structural stability may be added when hydroxide of nickel, oxide of nickel or carbonate of nickel is purified, or may be added as a compound when it is mixed with nickel hydroxide, nickel oxide or nickel carbonate. Types of elements to be added can be appropriately selected according to the properties of batteries, and one or combination of two or more can be used.

As the firing aid, it is preferable that a compound containing alkali metal, alkali earth metal or boron is used. Only particles of the compound containing alkali metal, alkali earth metal or boron as the firing aid are melted at a low temperature so as to generate a liquid phase between ceramic particles. The liquid phase allows the ceramic particles to attract to each other to make the gap therebetween smaller, thus facilitating sintering.

Examples of the alkali metal or the alkali earth metal include Na, K, Mg, Ca, Sr, and Ba excluding Li. As a compound of such elements, compounds such as chloride, hydroxide, acetate, sulfate, carbonate and nitrate are preferable. Specific examples of the compound include sodium chloride, sodium hydroxide, sodium acetate, sodium sulfate, sodium carbonate, sodium hydrogencarbonate, sodium nitrate, potassium chloride, potassium hydroxide, potassium acetate, potassium sulfate, potassium carbonate, potassium nitrate, magnesium chloride, magnesium hydroxide, magnesium acetate, magnesium sulfate, magnesium carbonate, magnesium nitrate, calcium chloride, calcium hydroxide, calcium acetate, calcium sulfate, calcium carbonate (limestone), calcium nitrate, strontium chloride, strontium hydroxide, strontium acetate, strontium sulfate, strontium carbonate, strontium nitrate, barium chloride, barium hydroxide, barium acetate, barium sulfate, barium carbonate, barium nitrate, and the like. Particularly preferable compounds are hydroxide and acetate.

Furthermore, examples of the compound containing boron include boric acid, lithium tetraborate, boron oxide, and ammonium pentaborate. A particularly preferable compound is boric acid.

An added amount of the firing aid is preferably at least 0.01 mass parts and at most 1.1 mass parts with respect to 100 mass parts of the above-mentioned material to be fired. When the added amount is less than 0.01 mass parts, an effect as the firing aid is poor. When the amount is more than 1.1 mass parts, the residual amount of the firing aid in the synthesized product becomes large, deteriorating the battery characteristics. Therefore, the added amount is preferably as small as possible. Furthermore, the added amount of the firing aid is more preferably at least 0.1 mass parts and at most 1.0 mass part. In other words, since the promotion effect of the crystallization in lithium nickelate is expressed when a proper amount of the firing aid is added, it is possible to take elements that contribute to the structural stability into the crystal at a lower temperature. Note here that after the active material is fired, the firing aid may remain in the active material. In such a case, the firing aid or oxide thereof is not taken into the lattice of the crystal of the active material, but it exists as mere impurities. Therefore, the firing aid is not material providing a substituted element for improving the properties of lithium nickelate.

Furthermore, it is preferable that the firing temperature is at lowest 700° C. and at highest 800° C. When the firing temperature is lower than 700° C., the effect of the firing aid cannot be sufficiently obtained. Meanwhile, when the firing temperature is higher than 800° C., a substitution reaction in which nickel (Ni²⁺) enters into a lithium (Li⁺) site easily occurs, and a structural irregularity in which nickel (Ni²⁺) exists in a lithium (Li⁺) site easily occurs. As a result, nickel (Ni²⁺) inhibits dispersion of lithium ions, adversely affects charge and discharge characteristics, and reduces the capacity. Hereinafter, the present invention is described specifically with reference to Examples and Comparative Examples, but the present invention is not limited to these Examples.

### EXAMPLE 1

Cobalt sulfate is added and dissolved in an aqueous solution of nickel sulfate containing nickel equivalent to metallic nickel of 60 g/L, so that the molar ratio of Co satisfies Ni:Co=80:20 so as to prepare an aqueous solution of a nickel-cobalt mixture. Furthermore, as an alkali agent, 25 mass % aqueous solution of sodium hydroxide is used. These are introduced into a 100 L-precipitation tank in such a manner that the aqueous solution of a nickel-cobalt mixture whose salt concentration is controlled so that the electric conductivity is 120 mS/cm at a constant amount of 10 L/h and the sodium hydroxide solution is introduced while it is stirred sufficiently. Thus, nickel hydroxide having a desired composition is produced. The obtained nickel hydroxide is heated at 500° C. to prepare nickel oxide (average particle diameter: 10 μm) as a nickel compound that is one material to be fired.

The nickel oxide and lithium hydroxide are mixed with each other so that an atomic ratio of lithium:(nickel+cobalt) becomes 1.03:1, and furthermore, 0.5 mass parts of sodium hydroxide (average particle diameter: 0.1 μm) as a firing aid is added with respect to the total mass of the materials to be fired. The mixture is fired in the atmosphere of air at 700° C. for 10 hours to prepare positive electrode active material No. 1 shown in Table 1.

Furthermore, the same synthesis procedure as mentioned above is carried out while the composition of the nickel compound, the composition of the firing aid, the additive amount of the firing aid and the firing temperature are changed so as to obtain positive electrode active material Nos. 2 to 60 shown in Table 1.

TABLE 1

| positive | | | added | |
|---|---|---|---|---|
| electrode | | | amount | |
| active | | composition | of firing | firing |
| material | composition of | of firing | aid | temperature |
| No. | nickel compound | aid | (wt %) | (° C.) |
| 1 | Ni_{0.8}Co_{0.2}(OH)₂ | NaOH | 0.5 | 700 |
| 2 | Ni_{0.8}Mn_{0.2}(OH)₂ | NaOH | 0.5 | 700 |
| 3 | Ni_{0.8}Al_{0.2}(OH)₂ | NaOH | 0.5 | 700 |
| 4 | Ni_{0.8}Mg_{0.2}(OH)₂ | NaOH | 0.5 | 700 |
| 5 | Ni_{0.8}Ti_{0.2}(OH)₂ | NaOH | 0.5 | 700 |
| 6 | Ni_{0.8}Sr_{0.2}(OH)₂ | NaOH | 0.5 | 700 |
| 7 | Ni_{0.8}Zr_{0.2}(OH)₂ | NaOH | 0.5 | 700 |
| 8 | Ni_{0.8}Y_{0.2}(OH)₂ | NaOH | 0.5 | 700 |
| 9 | Ni_{0.8}Mo_{0.2}(OH)₂ | NaOH | 0.5 | 700 |
| 10 | Ni_{0.8}W_{0.2}(OH)₂ | NaOH | 0.5 | 700 |
| 11 | Ni_{0.8}Co_{0.1}Mn_{0.1}(OH) | NaOH | 0.5 | 700 |
| 12 | Ni_{0.8}Co_{0.1}Al_{0.1}(OH) | NaOH | 0.5 | 700 |
| 13 | Ni_{0.8}Co_{0.2}CO₃ | NaOH | 0.5 | 700 |
| 14 | Ni_{0.8}Co_{0.2}O | NaOH | 0.5 | 700 |
| 15 | Ni_{0.7}Co_{0.3}(OH)₂ | NaOH | 0.5 | 700 |
| 16 | Ni_{0.9}Co_{0.1}(OH)₂ | NaOH | 0.5 | 700 |
| 17 | Ni_{0.8}Co_{0.2}(OH)₂ | NaOH | 0.009 | 700 |
| 18 | Ni_{0.8}Co_{0.2}(OH)₂ | NaOH | 0.01 | 700 |
| 19 | Ni_{0.8}Co_{0.2}(OH)₂ | NaOH | 0.05 | 700 |
| 20 | Ni_{0.8}Co_{0.2}(OH)₂ | NaOH | 0.1 | 700 |
| 21 | Ni_{0.8}Co_{0.2}(OH)₂ | NaOH | 0.7 | 700 |
| 22 | Ni_{0.8}Co_{0.2}(OH)₂ | NaOH | 1 | 700 |
| 23 | Ni_{0.8}Co_{0.2}(OH)₂ | NaOH | 1.1 | 700 |
| 24 | Ni_{0.8}Co_{0.2}(OH)₂ | NaOH | 1.2 | 700 |
| 25 | Ni_{0.8}Co_{0.2}(OH)₂ | NaOH | 1.5 | 700 |
| 26 | Ni_{0.8}Co_{0.2}(OH)₂ | NaOH | 0.5 | 690 |
| 27 | Ni_{0.8}Co_{0.2}(OH)₂ | NaOH | 0.5 | 710 |
| 28 | Ni_{0.8}Co_{0.2}(OH)₂ | NaOH | 0.5 | 750 |
| 29 | Ni_{0.8}Co_{0.2}(OH)₂ | NaOH | 0.5 | 800 |
| 30 | Ni_{0.8}Co_{0.2}(OH)₂ | NaOH | 0.5 | 900 |
| 31 | Ni_{0.8}Co_{0.2}(OH)₂ | H₃BO₃ | 0.5 | 700 |
| 32 | Ni_{0.8}Mn_{0.2}(OH)₂ | H₃BO₃ | 0.5 | 700 |
| 33 | Ni_{0.8}Al_{0.2}(OH)₂ | H₃BO₃ | 0.5 | 700 |
| 34 | Ni_{0.8}Mg_{0.2}(OH)₂ | H₃BO₃ | 0.5 | 700 |
| 35 | Ni_{0.8}Ti_{0.2}(OH)₂ | H₃BO₃ | 0.5 | 700 |
| 36 | Ni_{0.8}Sr_{0.2}(OH)₂ | H₃BO₃ | 0.5 | 700 |
| 37 | Ni_{0.8}Zr_{0.2}(OH)₂ | H₃BO₃ | 0.5 | 700 |
| 38 | Ni_{0.8}Y_{0.2}(OH)₂ | H₃BO₃ | 0.5 | 700 |
| 39 | Ni_{0.8}Mo_{0.2}(OH)₂ | H₃BO₃ | 0.5 | 700 |
| 40 | Ni_{0.8}W_{0.2}(OH)₂ | H₃BO₃ | 0.5 | 700 |
| 41 | Ni_{0.8}Co_{0.1}Mn_{0.1}(OH) | H₃BO₃ | 0.5 | 700 |
| 42 | Ni_{0.8}Co_{0.1}Al_{0.1}(OH) | H₃BO₃ | 0.5 | 700 |
| 43 | Ni_{0.8}Co_{0.2}CO₃ | H₃BO₃ | 0.5 | 700 |
| 44 | Ni_{0.8}Co_{0.2}O | H₃BO₃ | 0.5 | 700 |
| 45 | Ni_{0.7}Co_{0.3}(OH)₂ | H₃BO₃ | 0.5 | 700 |
| 46 | Ni_{0.9}Co_{0.1}(OH)₂ | H₃BO₃ | 0.5 | 700 |
| 47 | Ni_{0.8}Co_{0.2}(OH)₂ | H₃BO₃ | 0.009 | 700 |
| 48 | Ni_{0.8}Co_{0.2}(OH)₂ | H₃BO₃ | 0.01 | 700 |
| 49 | Ni_{0.8}Co_{0.2}(OH)₂ | H₃BO₃ | 0.05 | 700 |
| 50 | Ni_{0.8}Co_{0.2}(OH)₂ | H₃BO₃ | 0.1 | 700 |
| 51 | Ni_{0.8}Co_{0.2}(OH)₂ | H₃BO₃ | 0.7 | 700 |
| 52 | Ni_{0.8}Co_{0.2}(OH)₂ | H₃BO₃ | 1 | 700 |
| 53 | Ni_{0.8}Co_{0.2}(OH)₂ | H₃BO₃ | 1.1 | 700 |
| 54 | Ni_{0.8}Co_{0.2}(OH)₂ | H₃BO₃ | 1.2 | 700 |
| 55 | Ni_{0.8}Co_{0.2}(OH)₂ | H₃BO₃ | 1.5 | 700 |
| 56 | Ni_{0.8}Co_{0.2}(OH)₂ | H₃BO₃ | 0.5 | 690 |
| 57 | Ni_{0.8}Co_{0.2}(OH)₂ | H₃BO₃ | 0.5 | 710 |
| 58 | Ni_{0.8}Co_{0.2}(OH)₂ | H₃BO₃ | 0.5 | 750 |
| 59 | Ni_{0.8}Co_{0.2}(OH)₂ | H₃BO₃ | 0.5 | 800 |
| 60 | Ni_{0.8}Co_{0.2}(OH)₂ | H₃BO₃ | 0.5 | 900 |
| 61 | Ni_{0.8}Co_{0.2}(OH)₂ | — | — | 700 |
| 62 | Ni_{0.8}Co_{0.2}(OH)₂ | — | — | 800 |

Next, a cylindrical lithium secondary battery is produced by using the obtained positive electrode active materials.

### (Production of Positive Electrode)

Positive electrode active material No. 1 obtained above, carbon black as a conductive agent, and an aqueous dispersion of polytetrafluoroethylene as a binder are kneaded to be dispersed in each other in a mass ratio of solid contents of 100:3:10. This kneaded product is suspended in an aqueous solution of carboxymethyl cellulose to prepare a positive electrode paste. This positive electrode paste is applied onto both surfaces of a 30-μm thick positive electrode current collector made of aluminum foil by the doctor blade method to prepare a precursor of the positive electrode so that the total thickness is about 230 μm. Herein, the total thickness refers to the sum of thicknesses of the current collector and the paste applied onto both surfaces of the current collector.

After drying, the precursor of the positive electrode is roll-pressed to a thickness of 180 μm and cut into predetermined dimensions. Then, positive electrode lead 2 made of aluminum is welded to a portion of the positive electrode current collector on which a positive electrode active material layer is not formed. Thus, positive electrode 1 is produced.

### (Production of Negative Electrode)

Natural graphite as a negative electrode active material and a styrene-butadiene-rubber binder are mixed in a mass ratio of 100:5, and 1 wt % aqueous solution of carboxymethylcellulose (CMC) as a dispersion medium is added, kneaded to be dispersed in each other so as to prepare a negative electrode paste. This negative electrode paste is applied onto both surfaces of a 20-μm thick negative electrode current collector made of copper foil by the doctor blade method so that the total thickness is about 230 μm. Thus, a precursor of the negative electrode is produced. The total thickness refers to the sum of thicknesses of the current collector and the paste applied onto both surfaces of the current collector.

After drying, the precursor of the negative electrode is roll-pressed to a thickness of 180 μm and cut into a predetermined dimension. Then, negative electrode lead 4 made of nickel is welded to a portion of the negative electrode current collector on which a negative electrode active material layer is not formed. Thus, negative electrode 3 is produced.

### (Preparation of Non-Aqueous Electrolytic Solution)

A non-aqueous electrolytic solution is prepared by dissolving LiPF₆ as a solute at a concentration of 1 mol/L in a solvent obtained by mixing ethylene carbonate (EC) and diethyl carbonate (DEC) in a molar ratio of 1:3.

### (Assembly of Battery)

Positive electrode 1 and negative electrode 3 are spirally wound with separator 5 made of a 25-μm thick polyethylene microporous film disposed therebetween so as to produce electrode group 30. Electrode group 30 is placed into battery case 6, and the non-aqueous electrolytic solution is injected into battery case 6. Then, battery case 6 is sealed so as to produce a cylindrical lithium secondary battery.

Battery case 6 is sealed by crimping the open edge of battery case 6 onto the seal member via insulating gasket 10 in such a manner that the compression rate of insulating gasket 10 is 30%.

Battery No. 1 obtained above has a diameter of 18.0 mm, a total height of 65.0 mm, and a battery capacity of 2000 mAh.

### EXAMPLES 2 TO 60

Cylindrical lithium secondary batteries are produced in the same manner as in battery No. 1 except for using positive electrode active material Nos. 2 to 60 instead of positive electrode active material No. 1. The obtained batteries are referred to as batteries Nos. 2 to 60.

### COMPARATIVE EXAMPLES 1 TO 2

Cylindrical lithium secondary batteries are produced in the same manner as in battery No. 1 except for using positive electrode active material Nos. 61 and 62 instead of positive electrode active material No. 1. The obtained batteries are referred to as batteries Nos. 61 and 62.

Batteries No. 1 to 60 are subjected to aging at 45° C. for 24 hours for the purpose of stabilizing the inside of the batteries. After that, each battery is preliminarily charged and discharged at 25° C. In the preliminarily charge and discharge, the battery is discharged to 2.5 V at a constant current of 380 mA, followed by charging with a constant current of 1330 mA until a charging voltage reaches 4.2 V, then with the constant voltage until the charging current reaches 38 mA. Thereafter, 500 cycles of charge and discharge are carried out. Each cycle includes charging up to 4.2 V and discharging up to 2.5 V is carried out by the same conditions as mentioned above.

The initial discharge capacity and the discharge capacity retention ratio after 500 cycles with respect to the initial discharge capacity are shown in Table 2.

TABLE 2

| | initial | |
|---|---|---|
| battery | capacity | discharge capacity retention |
| No. | (mAh) | ratio after 500 cycles (%) |
| 1 | 2009 | 81 |
| 2 | 2008 | 82 |
| 3 | 2006 | 83 |
| 4 | 2007 | 82 |
| 5 | 2001 | 84 |
| 6 | 2004 | 83 |
| 7 | 2005 | 83 |
| 8 | 2006 | 83 |
| 9 | 2003 | 84 |
| 10 | 2002 | 84 |
| 11 | 2004 | 84 |
| 12 | 2002 | 84 |
| 13 | 2007 | 82 |
| 14 | 2008 | 82 |
| 15 | 1995 | 87 |
| 16 | 2020 | 80 |
| 17 | 1900 | 66 |
| 18 | 2003 | 83 |
| 19 | 2001 | 82 |
| 20 | 2020 | 83 |
| 21 | 2010 | 85 |
| 22 | 2010 | 80 |
| 23 | 1920 | 88 |
| 24 | 1430 | 83 |
| 25 | 600 | 45 |
| 26 | 1200 | 70 |
| 27 | 1950 | 84 |
| 28 | 1950 | 88 |
| 29 | 1600 | 90 |
| 30 | 1100 | 70 |
| 31 | 1999 | 86 |
| 32 | 2000 | 85 |
| 33 | 2000 | 85 |
| 34 | 1998 | 86 |
| 35 | 1997 | 88 |
| 36 | 2000 | 84 |
| 37 | 2001 | 84 |
| 38 | 1999 | 86 |
| 39 | 1997 | 87 |
| 40 | 1996 | 89 |
| 41 | 2000 | 84 |
| 42 | 1997 | 87 |
| 43 | 2001 | 86 |
| 44 | 2002 | 84 |
| 45 | 1992 | 89 |
| 46 | 2010 | 82 |
| 47 | 1870 | 67 |
| 48 | 2003 | 83 |
| 49 | 2001 | 82 |
| 50 | 2000 | 83 |
| 51 | 2000 | 85 |
| 52 | 2003 | 84 |
| 53 | 1900 | 89 |
| 54 | 1400 | 81 |
| 55 | 590 | 55 |
| 56 | 1100 | 80 |
| 57 | 1970 | 86 |
| 58 | 1980 | 90 |
| 59 | 1550 | 90 |
| 60 | 1000 | 74 |
| 61 | 1850 | 52 |
| 62 | 1550 | 77 |

From the comparison between batteries Nos. 1 to 60 and batteries Nos. 61 and 62, it is shown that the use of positive electrode active material obtained by firing with a firing aid added results in excellent charge and discharge characteristics and cycling characteristics. This suggests that at the time of synthesis of the positive electrode active material, elements that contribute to the structural stability are taken into a crystal, and positive electrode active material has little distortion of crystal and loss of oxygen, thus adsorption and desorption of lithium ions with respect to the inside of the crystal functions excellently.

To batteries Nos. 61 and 62, a firing aid is not added. Therefore, crystal growth is insufficient at 700° C., elements that contribute to the structural stability are not sufficiently taken in, and therefore the battery No. 61 shows an inferior result as compared with batteries No. 1 and No. 31. Furthermore, when firing is carried out at 800° C., elements that contribute to the structural stability are taken in, but distortion of crystal or loss of oxygen occurs. As a result, it is estimated that battery No. 62 has a smaller initial capacity than that of batteries 1 and 31, and has a smaller discharging capacity retention ratio than that of batteries No. 29 and 59.

As described above, when a firing aid is added, the crystalline property and a state of the loss of oxygen in positive electrode active material are thought to be more excellent as compared with the case where no firing aid is added. That is to say, the positive electrode active material produced by the manufacturing method according to this exemplary embodiment is thought to have a crystalline structure that is different from that of a conventional positive electrode active material having a similar composition, or have a subtly different composition.

As is apparent from the results of batteries No. 18 to 22, and 48 to 52, when the added amount of the firing aid is at least 0.01 mass parts and at most 1.0 mass parts, more excellent battery characteristics can be obtained.

As is apparent from the results of batteries Nos. 1, 27 to 29, 31, and 57 to 59, it becomes clear that when the firing temperature is at lowest 700° C. and at highest 800° C., more excellent battery characteristics can be obtained.

Note here that as shown in batteries 15, 16, 45 and 46, the same effect can be obtained even when a nickel compound whose composition ratio of Ni to an element such as Co or the like is changed is used.

Herein, results of examination of the ratio of the particle diameters of nickel oxide and the firing aid are described.

TABLE 3

| positive | | | | | | | discharge |
|---|---|---|---|---|---|---|---|
| electrode | nickel compound | | firing aid | | | | capacity |
| active | | average | | added | average | initial | retention ratio |
| material | | diameter | | amount | diameter | capacity | after 500 cycles |
| No. | composition | (μm) | composition | (wt %) | (μm) | (mAh) | (%) |
| 1 | Ni_{0.8}Co_{0.2}(OH)₂ | 10 | NaOH | 0.5 | 0.1 | 2009 | 81 |
| 1a | | | | | 1 | 2007 | 81 |
| 1b | | | | | 2 | 1990 | 77 |
| 31 | | | H₃BO₃ | | 0.1 | 1999 | 86 |
| 31a | | | | | 1 | 1998 | 86 |
| 31b | | | | | 2 | 1970 | 75 |

As shown in Table 3, when the particle diameter of the firing aid is not more than 1/10 with respect to the particle diameter of nickel oxide, an area in which nickel oxide and the firing aid are brought into contact with each other can be increased. Therefore, an effect as the firing aid is exhibited more efficiently.

Furthermore, results of examination of the temperature increasing conditions (profiles) at the time of firing are described. Note here that in the synthesis of positive electrode active material Nos. 1c and 31c, firing is carried out at the first heating temperature for 5 hours and then at the second heating temperature for 5 hours.

TABLE 4

| positive | | | | | | | discharge |
|---|---|---|---|---|---|---|---|
| electrode | | firing aid | | | | | capacity |
| active | composition of | | | melting | first heating | initial | retention ratio |
| material | nickel | | added amount | point | temperature | capacity | after 500 cycles |
| No. | compound | composition | (wt %) | (° C.) | (° C.) | (mAh) | (%) |
| 1 | Ni_{0.8}Co_{0.2}(OH)₂ | NaOH | 0.5 | 318 | — | 2009 | 81 |
| 1d | | | | | 320 | 2016 | 82 |
| 31 | | H₃BO₃ | | 169 | — | 1999 | 86 |
| 31d | | | | | 170 | 2007 | 86 |

As shown in Table 4, it is preferable that firing is carried out at the first heating temperature for a predetermined time, then the temperature is increased, and firing is carried out at the second heating temperature that promotes crystallization of lithium hydroxide and nickel oxide for a predetermined time. Note here that the first heating temperature is the melting point of the firing aid or higher, and less than the second heating temperature. The temperature is preferably up to a temperature that is higher than the melting point by 10° C. The second heating temperature is 700° C. to 800° C., inclusive. In this way, it is preferable that the temperature is maintained at the first heating temperature for a predetermined time, and then the temperature is raised to the second heating temperature. Thus, the firing aid can be reliably made into a melting state, and it can be brought into contact with nickel oxide, reliably.

Furthermore, in the above-mentioned examples, as the firing aid, NaOH and H₃BO₃ are used, but in addition to them, the compounds mentioned previously may be used. In this case, the same effect can be obtained.

### INDUSTRIAL APPLICABILITY

As mentioned above, a non-aqueous electrolyte secondary battery using positive electrode active material manufactured by a manufacturing method of the present invention has both excellent charge and discharge characteristics and cycling characteristics. Therefore, the non-aqueous electrolyte secondary battery of the present invention is useful as a power sources of, for example, portable devices.

### REFERENCE MARKS IN DRAWINGS

1 positive electrode
2 positive electrode lead
3 negative electrode
4 negative electrode lead
5 separator
6 battery case
7 annular support part
8 plate
9 cap (external connection terminal)
10 insulating gasket
11 upper insulating plate
12 lower insulating plate
13 upper valve
14 lower valve
17 PTC device
18 seal member
19 filter
30 electrode group

1. A manufacturing method of a positive electrode active material for a non-aqueous electrolytic solution secondary battery, the method comprising:
preparing a mixture of:
a nickel compound including Ni and at least one of elements selected from a group consisting of Co, Mn, Al, Mg, Ti, Sr, Zr, Y, Mo, and W,
a lithium compound, and
a firing aid; and
firing the mixture,
wherein a melting point of the firing aid is lower than a firing temperature of the mixture.

2. The manufacturing method of the positive electrode active material for a non-aqueous electrolytic solution secondary battery according to claim 1,
wherein the firing aid is at least one of chloride, hydroxide, acetate, sulfate, carbonate and nitrate of an alkali metal excluding Li.

3. The manufacturing method of the positive electrode active material for a non-aqueous electrolytic solution secondary battery according to claim 1,
wherein the firing aid is a compound of an alkaline-earth metal.

4. The manufacturing method of the positive electrode active material for a non-aqueous electrolytic solution secondary battery according to claim 1,
wherein the firing aid is at least one of boric acid, lithium tetraborate and ammonium pentaborate.

5. The manufacturing method of the positive electrode active material for a non-aqueous electrolytic solution secondary battery according to claim 1,
wherein in the preparing of the mixture, a ratio of the firing aid with respect to a total amount of 100 mass parts of the nickel compound and the lithium compound ranges from 0.01 mass parts to 1.1 mass parts, inclusive.

6. The manufacturing method of positive electrode active material for a non-aqueous electrolytic solution secondary battery according to claim 1,
wherein the firing temperature is 700° C. to 800° C., inclusive.

7. A positive electrode active material for a non-aqueous electrolytic solution secondary battery produced by a method comprising:
preparing a mixture of:
a nickel compound including Ni and at least one of elements selected from a group consisting of Co, Mn, Al, Mg, Ti, Sr, Zr, Y, Mo, and W,
a lithium compound, and
a firing aid; and
firing the mixture,
wherein a melting point of the firing aid is lower than the firing temperature.

8. A non-aqueous electrolytic solution secondary battery comprising:
an electrode group formed of:
a positive electrode including the positive electrode active material according to claim 7;
a negative electrode; and
a separator disposed between the positive electrode and the negative electrode, a non-aqueous electrolytic solution with which the electrode group is impregnated; and
a battery case accommodating the electrode group and the non-aqueous electrolytic solution.

9. The manufacturing method of positive electrode active material for a non-aqueous electrolytic solution secondary battery according to claim 1, wherein the firing of the mixture further includes:
heating the mixture to a first predetermined temperature so that only particles of the firing aid are melted, and subsequently heating the mixture to a second predetermined temperature higher than the first predetermined temperature.
